(19) United States
(12) Patent Application Publication
(10) Pub. No.: US 2012/0273371 A1
(43) Pub. Date: Nov. 1, 2012

(54) Packaging for Orthodontic Appliances

(76) Inventors: Juergen Bathen, McMinnville, OR (US); Klaus Hagelganz, McMinnville, OR (US); Rolf Hagelganz, Dundee, OR (US)

(21) Appl. No.: 13/454,943

(22) Filed: Apr. 24, 2012

Related U.S. Application Data
(60) Provisional application No. 61/480,007, filed on Apr. 28, 2011.

(51) Int. Cl. A61C 19/02

(52) U.S. Cl. 206/63.5

(57) ABSTRACT

A package for a set of orthodontic appliances includes a tray having a plurality of open pockets in which each pocket is sized and shaped to receive a selected orthodontic bracket according to its shape and dimensions such that each bracket is held snugly therein. The tray includes a tab at one end adapted to be grasped between a user's thumb and forefinger, and a cover is provided which is adapted for slideable engagement with the tray for covering the open pockets.

### CROSS-REFERENCE TO RELATED APPLICATIONS

This application claims the benefit of U.S. Provisional Patent Application No. 61/480,007 filed Apr. 28, 2011.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

1. Field of the Invention

Orthodontic brackets are small metal appliances that are adhered to the surface of a tooth. Frequently, such brackets are sold as a set. There is a unique bracket shape and design for each tooth. Some brackets have features, such as tie wings, not possesses by others. Some types of brackets have moving parts. Examples of various types of bracket design are shown in Hagelganz et al., U.S. Pat. No. 7,878,802, and in Hagelganz, published application US2011/0039225.

Brackets are tiny metal pieces and as such are easy to lose. Further, many bracket types are similar and if the parts of a set become jumbled together, it may be inconvenient to separate and positively identify each type according to its function.

Traditionally brackets have been packaged for sale in trays having square cut-out wells covered by a plastic transparent cover that either slides over the wells or snaps into place. However, the wells are a single size and shape, which means that the larger items may fit, but not snugly, and the smaller items rattle freely and may fall out.

2. Description of Related Art Including Information Disclosed Under 37 CFR 1.97 and 1.98

None.

### BRIEF SUMMARY OF THE INVENTION

A package for a set of orthodontic appliances includes a tray having a plurality of open pockets in which each pocket is sized and shaped to receive a selected orthodontic bracket according to its shape and dimensions such that each bracket is held snugly therein. The tray includes a tab at one end adapted to be grasped between a user's thumb and forefinger, and a cover is provided which is adapted for slideable engagement with the tray for covering the open pockets.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 is a sheet showing top, side and elevation views of a package for holding orthodontic brackets.

FIG. 2 is an end view of the package of FIG. 1.

FIG. 3 is a side view of the package of FIG. 1.

FIG. 4 is a three-dimensional perspective view of the package of FIG. 1 showing a partial bracket set displayed therein.

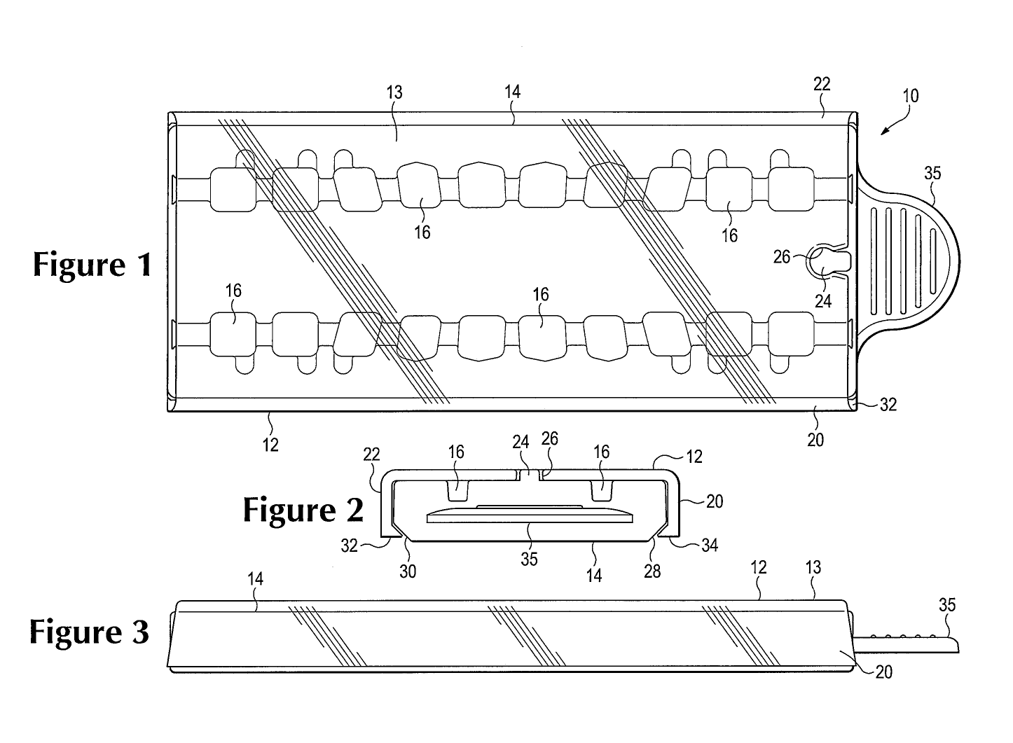

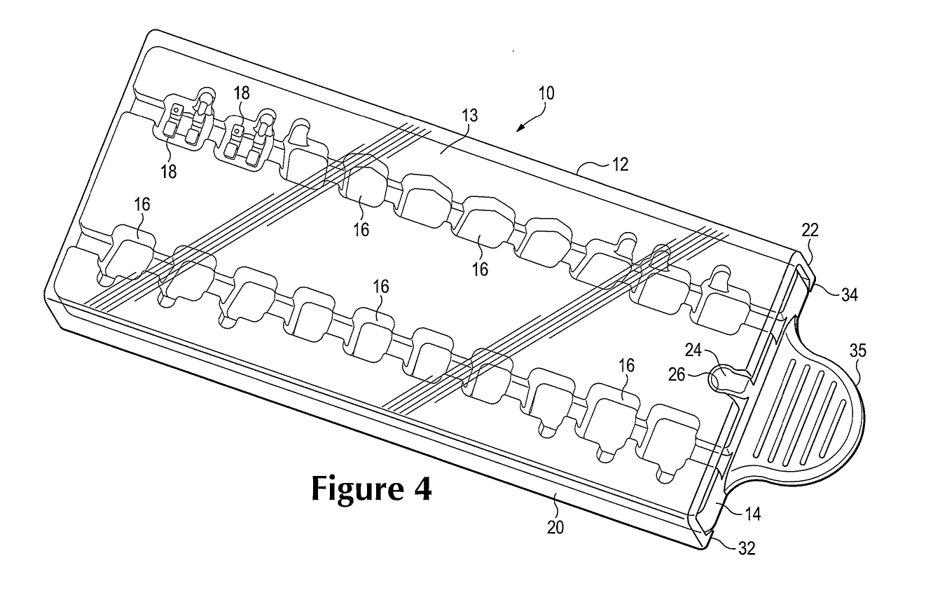

### DETAILED DESCRIPTION OF PREFERRED EMBODIMENT

According one embodiment, a package for a set of orthodontic brackets is provided which includes a tray and a cover. The tray contains sized and shaped pockets for a full set of orthodontic brackets. Each pocket is uniquely sized and shaped to fit a particular bracket type in a set, which includes a bracket for each tooth. A slideable cover contains the brackets within the pockets and may be transparent so that the user can see the entire set within. The set is arranged so that the pockets and associated brackets correspond to the exact order of a set of human teeth; that is, the brackets for the molars are at the ends of the package and brackets for the premolars, cuspids and incisors are placed in order toward the middle of the tray. The packaging of brackets in this way provides protection from counterfeiting of bracket sets because the package uniquely fits only brackets manufactured to exact tolerances and shapes. Thus, cheap imitation goods cannot fit in packaging designed only for manufacturers brackets made to specifications and thus cannot be passed off as genuine. Further by its position in the package the orthodontist knows exactly which tooth the bracket fits.

In addition, the trays are compact and stackable, which makes them especially useful in vending machines. Vending machines are used in orthodontic clinics as a means of inventory control, but such use requires careful packaging of the product. The low rectangular profile of the package lends itself to easy loading and manipulation in machines designed to eject small regularly shaped objects.

A tab or thumb pad at an end of the package permits it to be pulled out of a stack without causing the cover to slide off. This is accomplished by having a boss at the same end of the tray as the thumb pad. The boss locks to the cover by engaging a notch. Further, the covers have side bottom flanges, which are directed inwardly. These flanges have inner surfaces that are in sliding engagement with shaved or beveled bottom side edges on the trays.

Referring now to the drawings, a package 10 has two parts, a cover 12 and a tray 14. The tray 14 has a set of pockets 16. As shown best in FIG. 5, the pockets 16 hold orthodontic brackets 18 of various types. The pockets are arranged as an ordered set to correspond with the position of each tooth in a set of human teeth. Hence, bracket 18 (FIG. 4) are for third and second molars, and interior pockets are for brackets that go on internal teeth such as cuspids and incisors. There are twenty pockets 16 in each tray and these pockets hold a complete set of brackets 18 for all upper and lower teeth. The brackets are different and so the pockets in the tray 14 are shaped and sized to uniquely accommodate respective bracket types. The brackets fit closely in the pockets thus insuring that the package contains genuine manufacturer's brackets and not crudely manufactured counterfeits. This is because tolerances are maintained for the package tray pockets that fit the dimensions and shapes of the brackets very closely.

The cover 12 has a top 13, which is transparent, and sides 20 and 22 which fit the outer dimensions of the tray. The cover 12 slides onto the tray and the top 13 covers the pockets preventing the brackets, such as brackets 18, from dropping out of their pockets. The cover 12 is held in place by a boss 24 on the tray, which fits into a notch 26 in the cover 12. Also as shown best in FIG. 4, the bottom of the tray 14 has beveled or shaved sides 28 and 30. The cover 12 has lower side with extended lateral flanges 32 and 34 at the bottom of the cover 12. These two side flanges 32 and 34 engage the lower beveled edges 28 and 30 of the tray in sliding relationship thus forming a tight fit. The inner surfaces of the flanges thus slide along in contact with the outer surfaces of the beveled side edges of the tray. Thus, when the tray's boss snaps into the indentation on the cover, the package is tightly closed. The cover will not slide off of its own accord and the brackets are held securely inside, but are visible through the cover.

For ease of manipulation by a user, a thumb pad 35 is provided so that the package may be carried between thumb and forefinger. Depending upon the design of the vending machine holding the packages the thumb pad 35 may also be used to extract the package from the machine. The boss 24 is at the same end of the tray 14 as the thumb pad so that one may hold the thumb pad and pull back on the cover sliding it back to expose the pockets.

The terms and expressions that have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I claim:

1. A package for a set of orthodontic appliances, said set comprising an orthodontic bracket for each one of a full set of teeth, said package comprising a tray having a plurality of open pockets, each pocket in said tray being sized and shaped to receive a selected one of said brackets according to its shape and dimensions such that said brackets are held in said pockets snugly, said tray including a tab at an end thereof adapted to be grasped between a user's thumb and forefinger, and a cover adapted for slideable engagement with said tray for covering said open pockets when said cover is slid onto said tray.

2. The package of claim one where said tray includes a boss and said cover includes a notch at an end thereof which engages said boss in locking relationship.

3. The package of claim 1 wherein said cover includes a top and sides, said sides including lower flanged portions and wherein said tray includes lower side beveled edges which are engaged by said flanged portions in sliding relationship.

4. The package of claim 1 wherein said cover is transparent.

5. The package of claim 2 wherein said tab and said boss are at the same end of said tray.
